(19) United States
(12) Patent Application Publication
(10) Pub. No.: US 2002/0077898 A1
(43) Pub. Date: Jun. 20, 2002

(54) System and method for matching marketing collateral with specific customer information

(76) Inventor: Mitchell N. Koulouris, Elk Grove, CA (US)

Correspondence Address: John P. Costello, Weintraub Genshlea Chediak Sproul, 400 Capitol Mall, 11th Floor, Sacramento, CA, 95814, US

(21) Appl. No.: 09/741,714

(22) Filed: Dec. 19, 2000

(51) Int. Cl. G06F 17/60

(52) U.S. Cl. 705/14

(57) ABSTRACT

A computer system and method for matching an item sold, such as a product or service, with an advertisement, brochure, coupon, or other marketing piece, collectively called “collateral.” The method allows a computer system to be used to match a piece of collateral with an item according to the preferences of a party who has a vested interest in seeing the collateral placed with a certain item. The result is that the collateral will not be placed with the sold item at random, and instead will be placed in shipping containers with the item in a targeted manner. The invention is also a computer system whereby the method can be implemented.

### BACKGROUND OF THE INVENTION

1. Field of the Invention

This invention pertains to systems and methods for more efficiently marketing products and services through a computer system, and more specifically, to systems and methods for more efficiently marketing products from a computer system by matching marketing collateral to the purchasing habits of a customer.

2. Description of the Background Art

The internet has become a common route through which the sale of products and services occur. With regard to products sold through the internet, these items are shipped to customers by common air or ground methods of transportation, typically in a container of some sort. Often times, in an attempt to garner additional sales of other products or services, the shipper of the item will include a number of textual marketing pieces such as catalogs, brochures, flyers, and coupons, in the shipping container. These marketing pieces are collectively termed “collateral,” in the shipping industry. Collateral can represent advertisements for additional products or services offered by the seller of the item placed in the container, or else it can represent advertisements for other products or services offered by entities unrelated to the seller.

With present methods, this collateral is manually placed inside a shipping container, either randomly, or with some selectivity, on the part of the shipper. If selectivity is employed, a shipper who sells camping supplies for example, might include a bundle of collateral which pertains to camping accessories. In the random case, collateral is exchanged between companies, often within a particular industry group, so that collateral representative of the products and services sold within a particular industry are enclosed within the shipping containers of all the members of that industry. As such, customers who purchase items from a number of members of a certain industry, often end up with the same collateral, contained in every shipping container received by the customer. Upon opening the shipping container, the customer is often confronted by a morass of collateral, which often times is unrelated to the customer's buying preferences, and as such, is generally thrown away, without being read by the customer.

A major drawback to this manual method of placing collateral is that the selection of collateral is at the sole control of the shipper, without any input from the party whose products or services are being marketed on the collateral. Typically, it is the party whose products or services which are advertised on the collateral who has the most knowledge as to the demographics of its customer base. Therefore, it is this party who knows best where to place its collateral for maximum advertising return. Under present methods and systems, the knowledge of this party is not being effectively utilized.

Another drawback to present day collateral placement methods is that they have not adequately exploited the power of computer systems linked to the internet. The internet has allowed anyone to set up a Web site “store-front” for the sale of products and services, without having to invest in a physical location, and in some cases, inventory. This reduced barrier to market entry has resulted in an explosion of products and services being sold upon the internet through computer systems linked thereto, and this has resultantly opened up a whole new avenue for collateral marketing. Every product or service being sold on the Web is potentially a product or service which could be delivered with an associated assembly of marketing collateral. While collateral is being presently placed with items sold on the Web, by the manual methods previously described, no known methods for strategically placing collateral through the use of a computer system are presently being used.

Therefore, the lack of a known method for strategically placing collateral using a computer system has resulted in less efficiency with regard to collateral marketing programs. The present invention is a business method and a computer system for implementing the method, which greatly increases the efficiency of collateral marketing, and provides a highly focused and targeted method for prospecting qualified customers. This specific targeting of customers being based upon their demographics, is directed toward achieving increased sales.

The foregoing reflects the state of the art of which the inventor is aware and is tendered with a view toward discharging the inventor's acknowledged duty of candor in disclosing information, which may be pertinent to the patentability of the present invention. It is respectfully stipulated, however, that the foregoing discussion does not teach or render obvious, singly or when considered in combination, the inventor's claimed invention.

### SUMMARY OF THE INVENTION

By way of example and not of limitation, the present invention pertains to a computer system and method for more efficiently matching collateral with specific customer information.

Under the system and method described herein, the collateral is matched according to the knowledge or instruction of the party having the highest vested interest in seeing its collateral properly placed. This “vested” party can be the entity who is offering the product or service described in the collateral, for example, and therefore, this party desires that its collateral be properly placed with the product or service being sold by the proprietor of a computer system.

Additionally, the invention contemplates having this vested party gain access to a second party proprietor's computer system, for purposes of choosing the type of product or services for which the vested party's collateral will be associated. These vested parties, being termed “subscribers,” from this point on, would subscribe to the proprietor's computer system through a Web site interface, and gain access thereto, for purposes of placing their collateral with the products and services sold by the proprietor through its computer system. Upon gaining access to the computer system, the subscriber would make its choices as to which products or services (collectively called “items” herein) to which the subscriber will match its collateral. In this way, the subscriber can essentially create a custom collateral marketing program on a second party's computer system.

This invention also comprises the computer system through which the collateral is matched with an item.

### BRIEF DESCRIPTION OF THE DRAWINGS

The invention will be more fully understood by reference to the following drawings which are for illustrative purposes only:

FIG. 1 is a block diagram of the general method for matching a piece of collateral to a transacted item through the use of a computer system.

FIG. 2 is a block diagram of the method described in FIG. 1 with additional detail describing the generation of a pick list which is used for placing collateral with an item for shipment to a destination.

FIG. 3 is a block diagram of the computer system which executes the method for matching a piece of collateral to a transacted item.

FIG. 3A is a block diagram of a second embodiment of the computer system which executes the method for matching a piece of collateral to a transacted item, this computer system having a postal code database.

FIG. 4 is an items database which is a component of the computer system shown in FIG. 3.

FIG. 4A is a representation of the preferred structure of items database shown in FIG. 4.

FIG. 5 is a subscriber database which is a component of the computer system shown in FIG. 3.

FIG. 6 is a form for registering subscribers with the computer system shown in FIG. 3.

FIG. 7 is the collateral matching process which is a component of the computer system shown in FIG. 3.

FIG. 7A is a second embodiment of the collateral matching process which is used to match additional information, such as postal code information, to a piece of collateral designed for a specific country or region of the world.

FIG. 8 is a pick list shown here to be in the form of a printed invoice.

### DESCRIPTION OF THE PREFERRED EMBODIMENTS

### General Description of the Method and Computer System

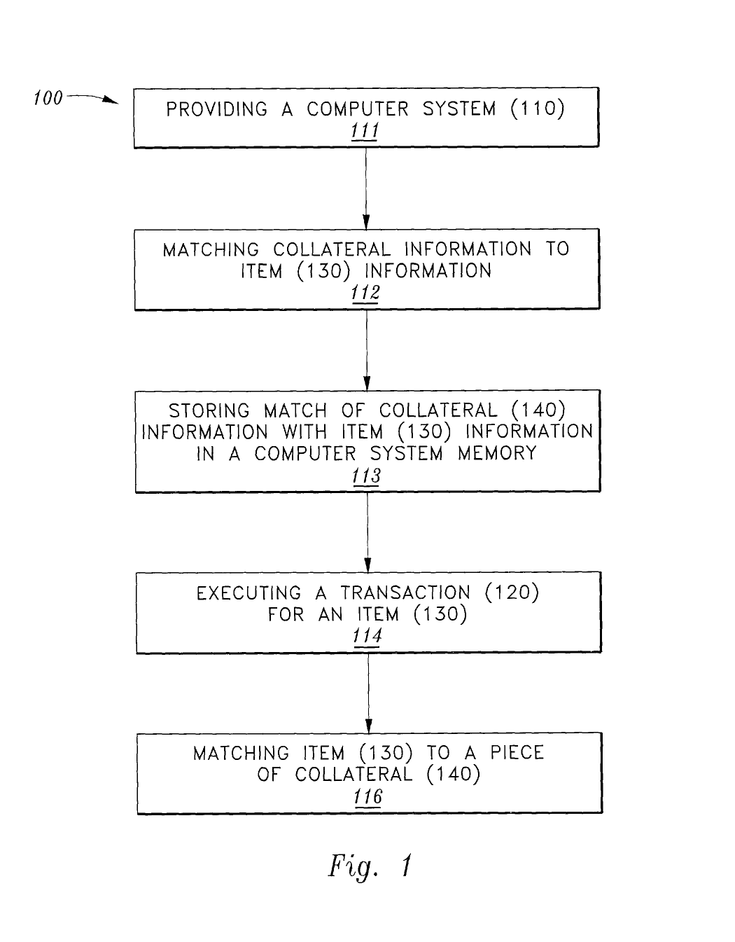

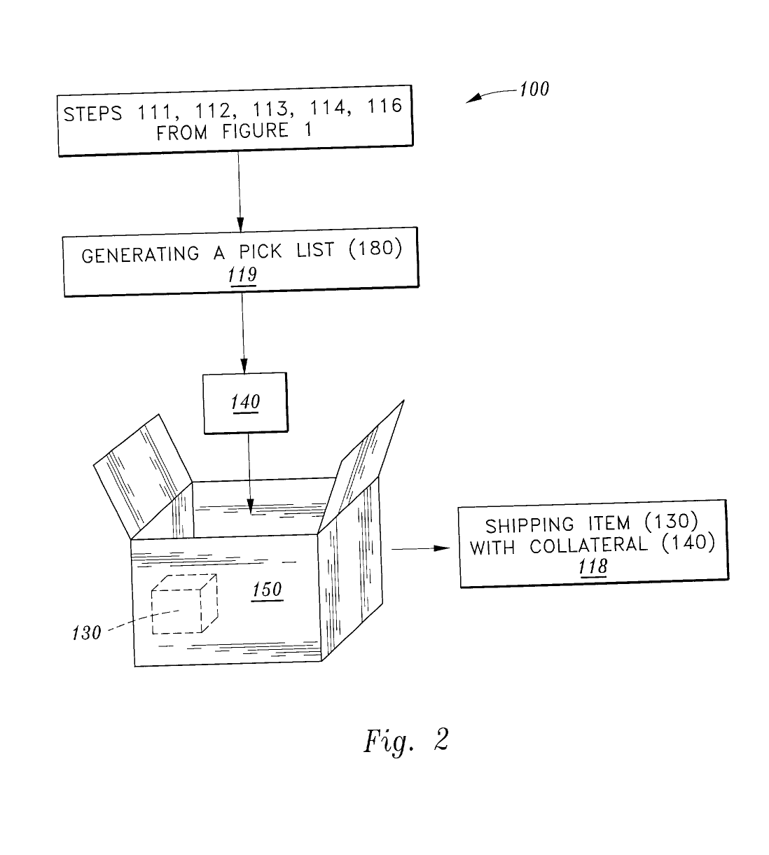

Referring more specifically to the drawings, the present invention is generally shown in FIG. 1, which is a block diagram illustrating the general method 100 portion of the invention and the computer system 110 through which the method 100 is implemented. Method 100 involves providing 111 a computer system 110 by which a user of the computer system 110 matches 112 information relating to a piece of collateral 140 with information relating to an item 130, such as a product or service, and subsequently storing 113 information relating to this match in the computer system's memory. Next, upon executing 114 a transaction 120 for the item 130 computer system 110 automatically matches 116 the item 130, with a specified piece of marketing collateral 140 according to the prior matches 112 selected by the user, and stored 113 within the computer system memory, so that the collateral 140 is shipped (118—this step is shown in FIG. 2) with the item 130. While the remainder of the description herein will discuss the transaction 120 involving the item 130 in terms of a sale, the transaction is not limited to a sale of an item, but can be a rental, lease, option, gifting or other transaction, as well.

The collateral 140 which is shipped (118) along with the item 130 is typically a textual marketing piece such as a catalog, brochure, flyer, or coupon. However, in addition to purely textual marketing pieces, collateral 140 may include any other marketing tool, such as a printed T-shirt, coffee cup, compact disk or office toy. Also, collateral 140 may be of digital quality, such as an electronic mail (e-mail) promotion. Finally, while the method shown in the drawings teaches shipping the collateral along with the item being sold, it is envisioned by the inventor that the collateral may also be shipped separately from the sold item 130.

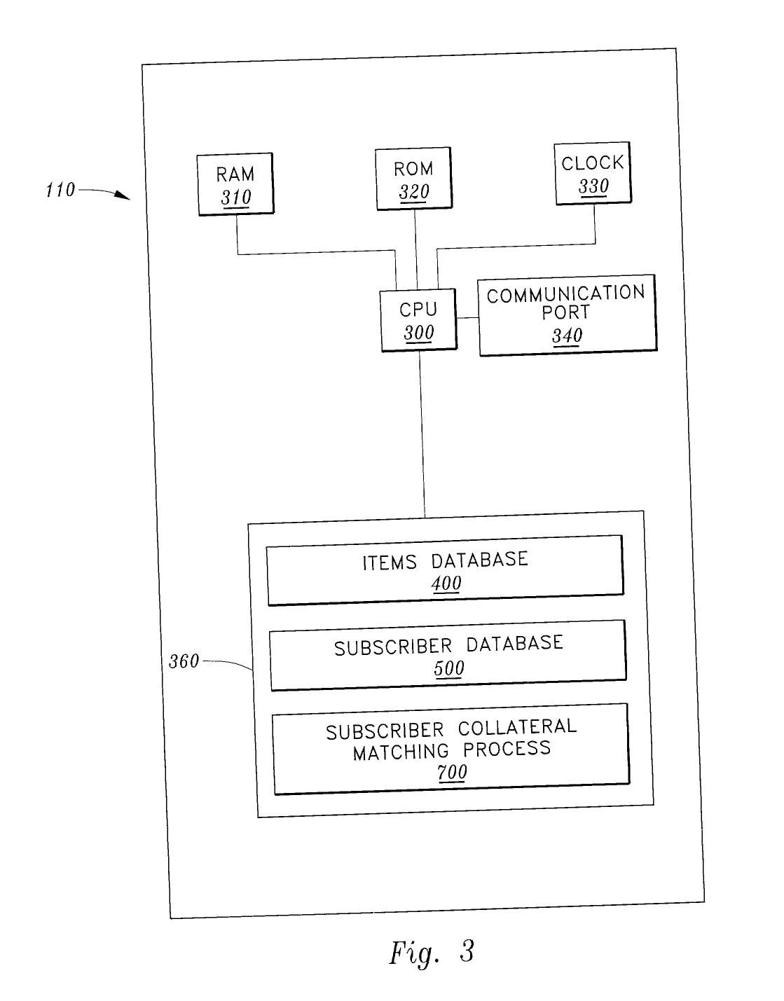

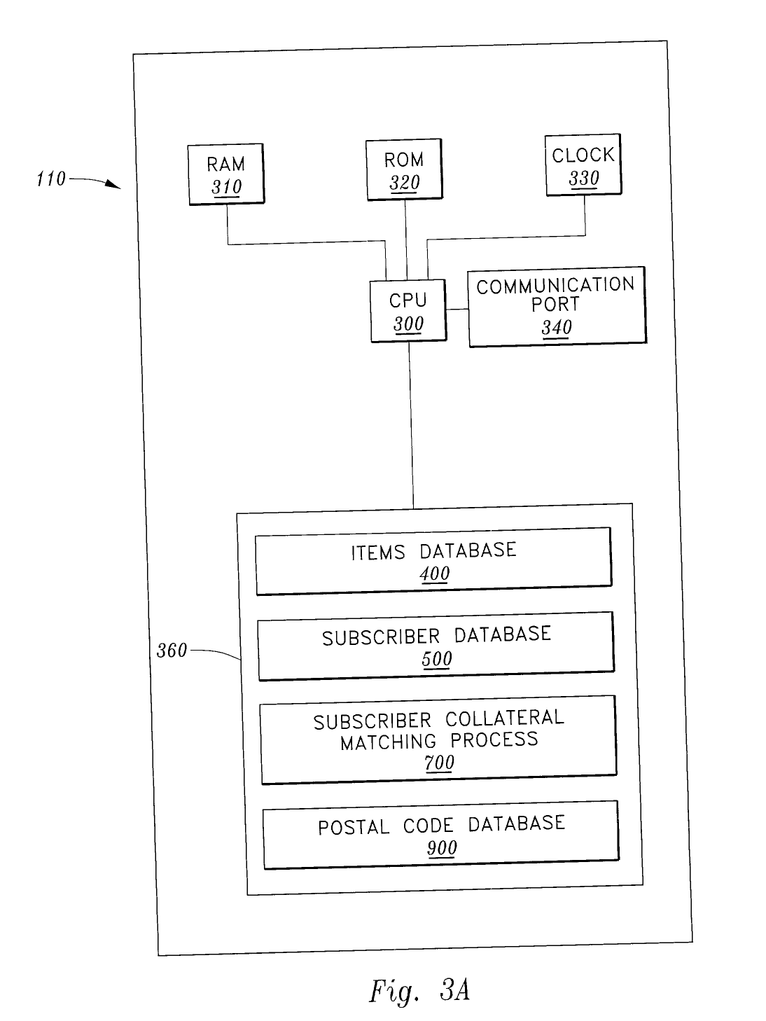

As shown in more detail in FIG. 2, the method includes steps 111, 112, 113, 114, 116 as described previously, in conjunction with FIG. 1, and further comprises the step of generating 119 a pick list 180 wherein the pick list comprises instructions regarding matches 116 of items 130 with collateral 140 in either a printed format or a digital format. If the collateral is to be manually placed in a shipping container with an item, then a printed pick list 180, in the form of an invoice, for example, is used. If the collateral 140 is placed in a shipping container 150 with an item 130, by automated means, then the pick list would be digital instructions to collateral printing and sorting machinery, for example. After the collateral and item are matched in the shipping container 150, the item and collateral are shipped 118 to their destination. The manner in which the system 110 matches collateral piece 140, with the item 130, is described in further detail in conjunction with drawing FIGS. 3-7 below.

### The Computer System

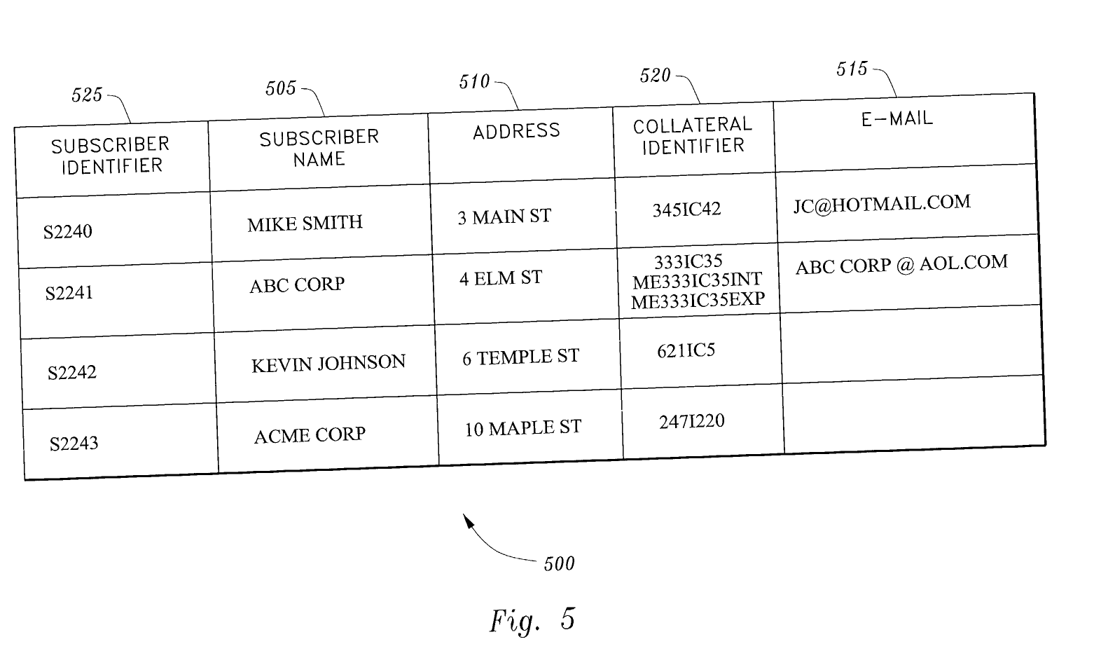

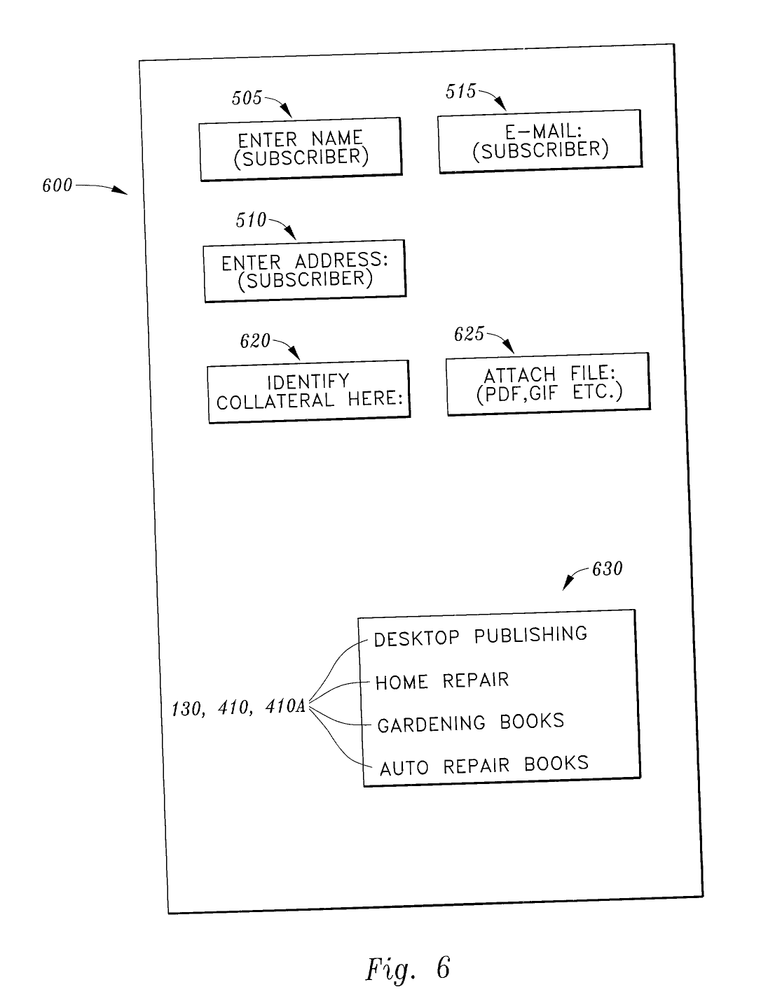

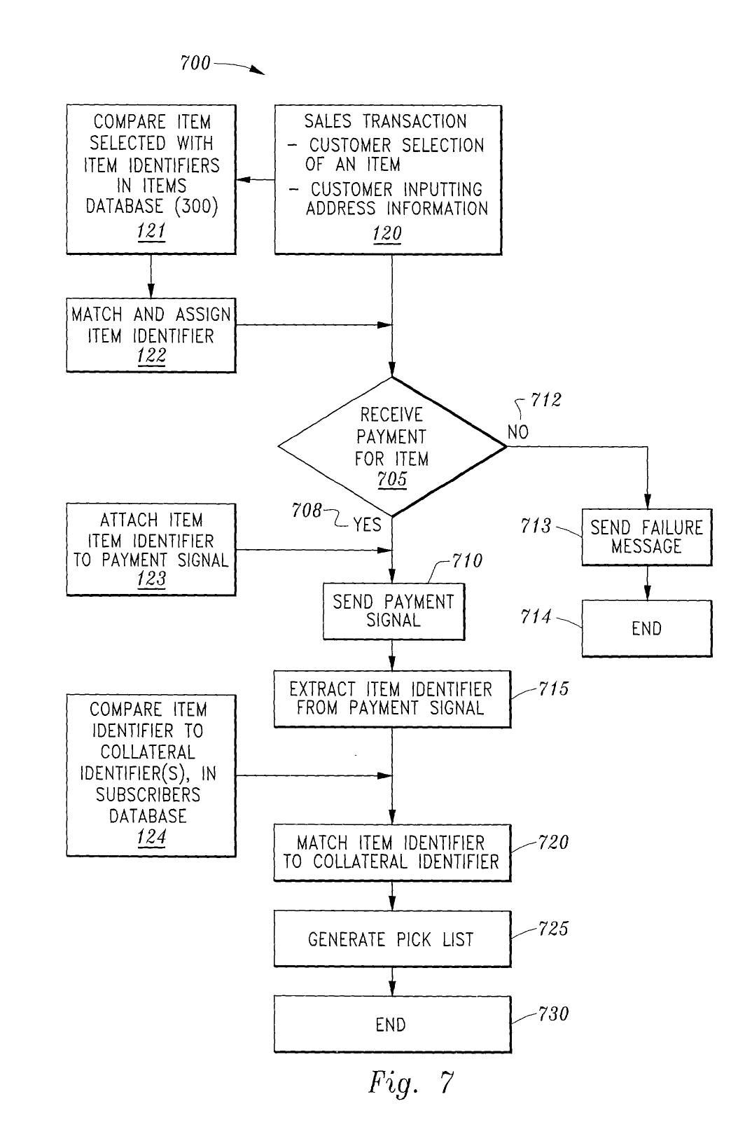

FIG. 3 is a block diagram showing the architecture of an illustrative computer system 110, through which method 100 can be implemented. The computer system 110 through which method 100 is implemented, is preferably an in-house personal computer (PC) which can be stand-alone, or networked, with other computers, by way of a local area network (LAN) or wide area network (WAN). In the case where a WAN is used, this is often where the item 130 and collateral 140 are located at a shipping facility, which is physically separate from where the PC executing 114 the transaction 120 is located. Computer system 110 includes standard hardware components such as a central processing unit (CPU) 300, a random access memory (RAM) 310, a read only memory (ROM) 320, and a clock 330. The CPU 300 can be linked to each of the other listed elements, either by means of a shared data bus, or dedicated connections, as shown in FIG. 3. The communications port 340 connects the computer system 110 to buyers and sellers of the items 130, through the Web, for example, as well as connects subscribers having access to computer system 110, as further described below in conjunction with FIGS. 5 and 6.

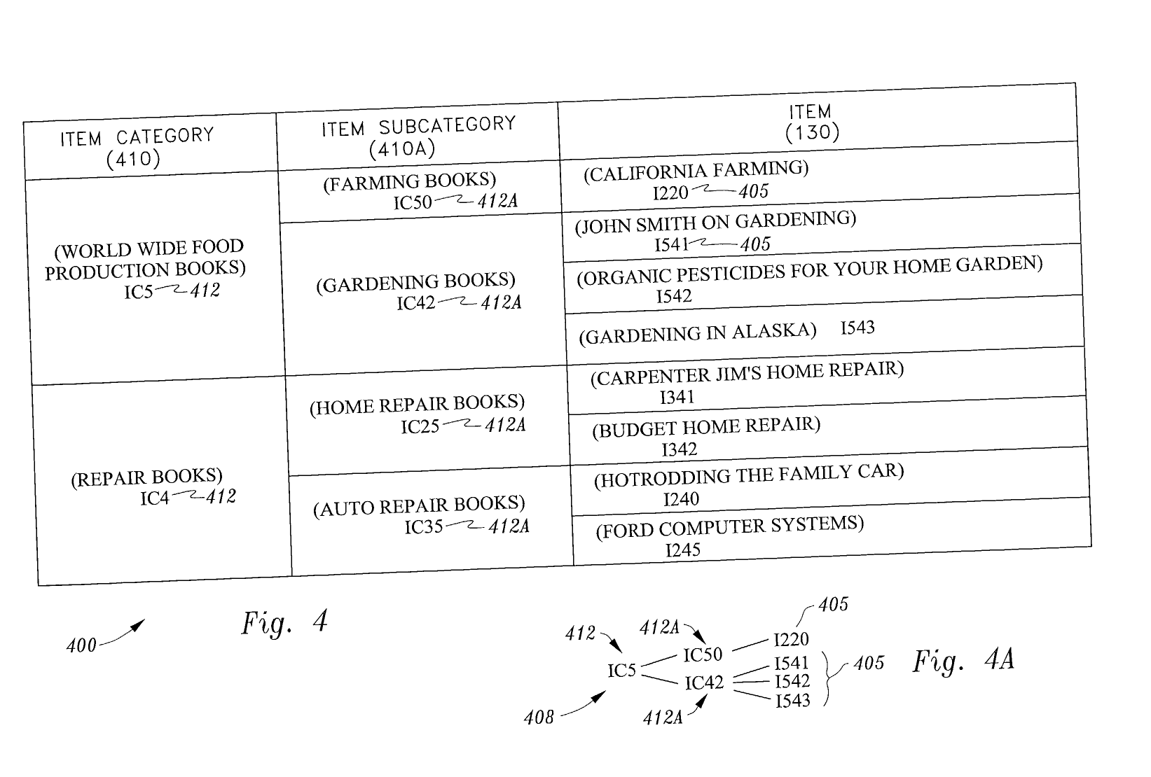

The ROM 320 and/or data storage device 360 are operable to store one or more instructions, which the CPU 300 is operable to retrieve, interpret and execute. For example, the ROM 320 and/or data storage device 360 can store process (700) and information in databases (400, 500) to accomplish the matching of an item 130 with collateral 140 selected to be associated with the item 130, as shown in more detail in FIGS. 4-7, and described below.

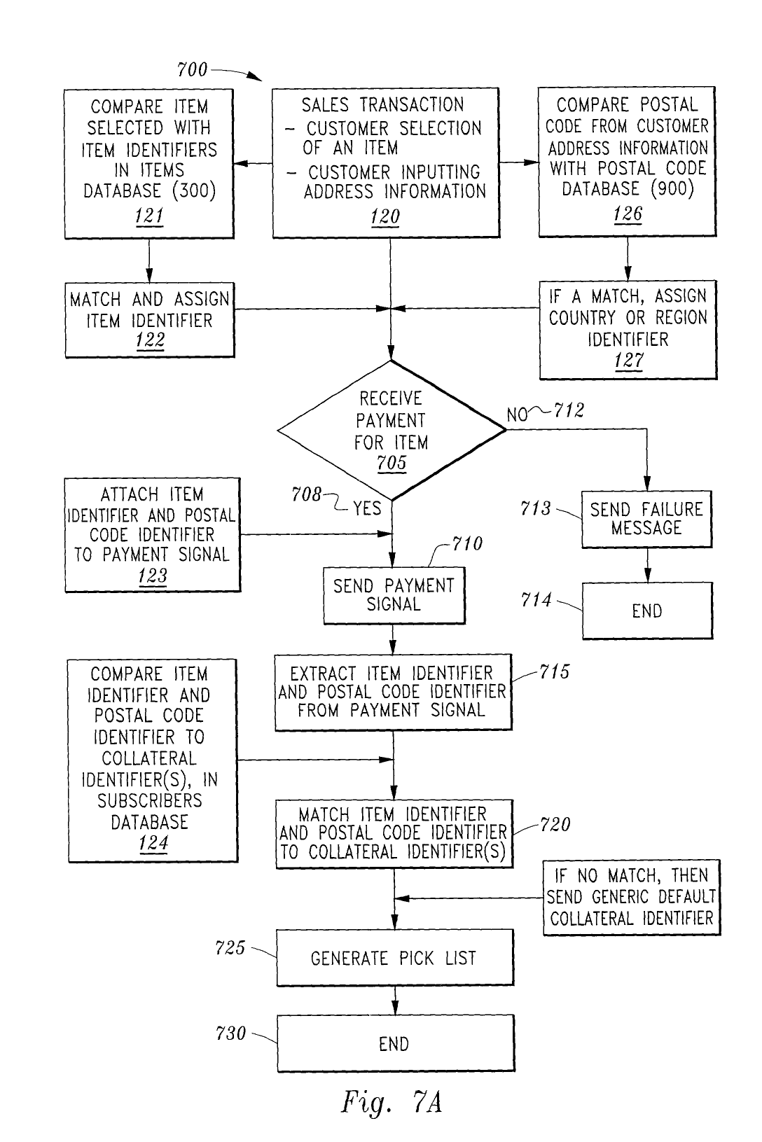

Referring still to FIG. 3, the data storage device 360 of computer system 110 includes, an items database 400, subscriber database 500 and a collateral matching process 700. The items database 400 stores information on the item categories (410, 410A) and various items 130 for sale on computer system 110. The subscriber database 500 stores biographical information (505, 510, 515) on subscribers, and information relating to collateral matches with items 130, this information being stored in database 500 in the form of collateral identifiers (520), described further below in conjunction with FIG. 5. The collateral matching process 700 is preferably a software program which takes information from the items database 400 and information from the subscriber database 500 and processes this information in a way shown in FIGS. 7, or 7A, such that a subscriber's collateral 140 is matched with an item 130 upon the execution of a sales transaction 120.

While the basic computer system architecture for carrying out the invention is shown in FIG. 3, additional databases corresponding to desired criteria to be associated with collateral identifiers (520) can be added to the basic architecture. FIG. 3A exemplifies such a computer system 110 wherein a postal code database 900 is added so that collateral identifiers (520) can be matched to the postal codes inputted by customers purchasing items 130 for purposes of sending the customer collateral 140 that is strategically tailored to country or region specific languages, customs, and preferences.

### The Items Database

FIG. 4 illustrates an exemplary items database 400 component of computer system 110, which stores information on item categories 410 and their associated items 130. Each item 130 corresponds to an item identifier 405 which in turn corresponds to at least one item category identifier 412, 412A. Each item category identifier 412, 412A corresponds with at least one item category 410 or subcategory 410A. For illustrative purposes, items database 400 lists the items 130, along with their corresponding item identifiers 405. Using “Gardening Books” as an example item subcategory 410A, this is identified with item subcategory identifier 412A designated as “IC 42.” This item subcategory identifier 412A corresponds with three item identifiers designated in FIG. 4 as “I541” (for a book entitled: “John Smith on Gardening”), “I1542” (for a book entitled: “Organic Pesticides for your Home Garden”) and “I543” (for a book entitled “Gardening in Alaska”). Also, as shown, item subcategory 410A (Gardening Books) is a subset of a broader item category 410, namely “Worldwide Food Production Books”, this item category being assigned the item category identifier 412 of “IC5.”

FIG. 4 shows the names of item categories 410, subcategories 410A, and items 130, in parentheses, corresponding with item category identifiers 412, 412A and item identifiers 405, respectively. However, items database 400 preferably includes only the item identifiers 405 and item category identifiers 412, 412A which are preferably numeric or alpha-numeric codes assigned to each item category, subcategory, or item. These identifiers 412, 412A, 405 are necessary to allow the computer system 110 to recognize selections of item categories and/or to match an item selected by a customer, to a piece of collateral, upon the execution of a sales transaction, as further described below.

As shown in FIG. 4A, the preferred structure 408 of database 400 is that of an expanding “tree” format, wherein the broadest item category identifiers 412 correspond to one or more subcategory identifiers 412A and that these subcategories correspond to one or more item identifiers 405 at the final destination in the structure 408 of database 400. The items 130, and therefore, the item identifiers 405 represent the final destination in the structure 408 of items database 400 because all item categories 410 and subcategories 410A eventually drill down to the item 130.

The maintenance of items database 400 is preferably left with the proprietor of the computer system 110 who owns and operates system 110, and who typically sells products or services there through. The proprietor would have the responsibility of inventing and storing item categories and items in items database 400. Additionally, the computer system proprietor maintains the items database 400 by regularly updating the item identifier 405 portion of the items database 400, by matching new item identifiers 405 with corresponding item category identifiers 412, 412A or removing item identifiers 405 altogether, as items 130 are no longer being sold by a proprietor. However, typically, the item category identifiers 412, 412A remain the same, and do not change, unless, of course, an entire category is removed or added, by the proprietor. The proprietor can be linked to items database 400 by way of a browsable catalogue which organizes item categories 410, 410A and items 130 on a computer screen, this browsable catalog being organized in the preferred expanding tree format described previously in FIG. 4A.

The item categories 410, 410A or items 130 are browsable by any user having access to computer system 110, which can be the proprietor or a subscriber to system 110, as further described below. Upon browsing through the catalog, a user having access, can choose which item categories or items will be associated with a particular piece of marketing collateral 140. Typically, the user can browse the item categories (e.g. Gardening Books, Home Repair Books) or items and select those which the user believes will be the best categories or items for which to place a piece of collateral 140. The collateral 140 must be associated with the party having a vested interest in seeing it properly placed with an item 130 in a shipping container 150. The vested party can be the proprietor trying to place its own collateral on its own computer system 110, or else be a subscriber to the computer system, trying to place its collateral through the proprietor's computer system 110.

In the case where a subscriber is the vested party, a subscriber database 500 must be added to system 110 for purposes of containing information relating to the subscriber, among other features. This subscriber will preferably subscribe to computer system 110 for purposes of being included in a subscriber database 500, as further described in conjunction with FIG. 5, below.

### The Subscriber Database

FIG. 5 illustrates an exemplary subscriber database 500, which stores information on subscribers to system 110, and stores information on the collateral 140 that is matched with desired items 130. Subscriber database includes biographical data 505, 510, 515 on the subscriber, a subscriber identifier 525 and a collateral identifier 520, which identifies collateral 140 to be matched with an item 130 by a subscriber, according to customer demographics known to the subscriber. The information shown to be included in subscriber database 500 is preferably entered therein through a registration form (600) of the type shown and described in FIG. 6, below.

FIG. 6 illustrates a registration form 600 for registering subscribers with computer system 110 and automatically matching collateral with a subscriber. Biographical data 505, 510, 515 relating to the subscriber is entered at appropriate locations on the form 600. This registration form 600 could be of a Web page variety, and be accessible to a subscriber via an access code given to the subscriber by the proprietor of computer system 110. A browsable catalogue 630 is provided on form 600 listing various item categories 410, 410A and items 130, which are preferably organized in the expanding tree structure noted in FIG. 4A above. Form 600 also provides a location 620 to identify collateral. The collateral could be delivered to the proprietor of system 110 by the subscriber through various means. For example, the subscriber could print and mail its collateral to the proprietor by conventional printing means. Alternatively, as shown in registration form 600 a PDF file 625, containing a representation of the intended collateral, could be digitally attached to form 600 by means well known in the computer arts. From this PDF file a proprietor of system 110 could have the collateral generated through a print-on-demand system, for example. The print-on-demand system would keep the subscriber's PDF file stored in memory so that whenever a demand for a subscriber's collateral was requested, the collateral could be generated at will. Also, a print-on-demand system could be a portion of the system 110 which automatically prints and places collateral 140 in the shipping containers 150.

Upon a user matching a piece of collateral 140 with the item categories 410, 410A or items 130, selected from the browsable catalogue 630, form 600 could be submitted to system 110. Upon submitting form 600, system 110 would automatically assign a collateral identifier 520 and a subscriber identifier 525 to subscriber database 500 for storage therein. The basic collateral identifier 520 is preferably an alph-numeric combination of a number identifying the collateral (e.g. “345”) and item category identifiers 412, 412A. For example if a subscriber identifies a brochure as its collateral, the brochure would be assigned the number “345” by system 110, and if the item category for Gardening Books which has item category identifier “IC 42” is selected to be matched to the brochure, the entire collateral identifier would be “345IC42.” Subscriber identifier 525 is automatically matched to the subscriber's biographical data 505, 510, 515, and to the collateral identifier 520 in subscriber database 500, these matches being stored in the computer system's memory.

### Creating a Strategic Collateral Identifier

While the basic collateral identifier 520 has been described thus far in terms of a means for generally placing an item 130 with collateral 140, the collateral identifier 520 can also be designed to carry additional information which further insures the strategic placement of different types of collateral 140 with a particular customer base. For example, giving the vested party the option of providing country or region specific collateral 140 with the computer system's proprietor would aid the vested party in further penetrating local markets. This country or region specific collateral 140 might include marketing information for a product or service in a local language or dialect. This collateral 140 might also provide prices for products or services in various country or region specific monetary denominations. This region or country specific collateral 140 could also be designed to adhere to localized advertising customs and designs, which are familiar in different parts of the world. Finally, the collateral identifier 520 could also be designed to be specific to different “user levels” present in a customer base, such as novice, intermediate, and expert, if appropriate.

The vested party, be it a subscriber, proprietor or other user trying to place its collateral, would have to provide the appropriate additional information (country, user level, other information) regarding collateral identification, to computer system 110 in the manner previously described at position 620, in FIG. 6. Upon entering this additional information, further alpha or numeric identifiers could be automatically added to the collateral identifier 520, by computer system 110, which correspond to this additional information.

In operation, and again referring to FIG. 4, a vested party might find a wide geographic range of appeal for the Auto Repair Book subcategory 410A (IC 35), this subcategory being associated with two book items 130 “Hot rodding the Family Car” (I240) and “Ford Computer Systems” (I 245). Therefore, the vested party would be wise to place a wide range of country or region specific collateral 140 with these categories and/or items (e.g. The vested party would have collateral pre-designed for the UK, Japan, Mexico, etc). Likewise, different user levels could be specified, which would be appropriate for technical items such as “Ford Computer Systems,” which might appeal to only a very small, expert level customer. As such, a very specific collateral piece could be designed and placed with that customer, which would offer products and services that are especially appealing; hopefully resulting in the generation of the added sales of products or services described on the collateral 140.

Upon the vested party inputting the additional information relating to the collateral 140 previously described, computer system 110 would generate and store in memory a number of collateral identifiers 520 corresponding to the different specific types of collateral 140. For example, a vested party having an interest in placing its collateral with all items under the Auto Repair Book subcategory 410A might identify two separate pieces of collateral 140 with two separate countries and two separate user levels. If such an identification is made on a form of the type shown in FIG. 6 at position 620, a plurality of check boxes for a corresponding plurality of countries and user levels could be placed at position 620 by methods well known in the computer arts. If two countries (e.g.

Mexico, Canada) and user levels (e.g. intermediate, expert) are chosen by the vested party, computer system 110 would generate appropriate collateral identifiers 520 after the vested party inputs these selections.

In operation, a collateral identifier 520 for Mexico designed for an intermediate user level might be “ME333IC35INT” (here the computer has assigned the designator “ME” for Mexico and the designator “INT” for intermediate, along with the basic collateral identifier “333IC35”). A collateral identifier for Mexico and an expert user level would likewise be “ME333IC35EXP.” These collateral identifiers are shown in FIG. 5, in the subscriber database, as associated with “ABC Corp.” as the vested party.

If no check boxes for additional information are designated by the vested party at position 620, then the basic collateral identifier “333IC35” would be generated as a default collateral identifier by computer system 110, and stored in memory; the corresponding collateral piece would also be of a uniform, default variety (e.g. a piece in a uniform, well known language such as English designed for an intermediate user level).

### Customer Selection of an Item for Purchase

A customer can select an item for purchase in a couple of ways, but the invention is in no way limited to these ways only. The first way is for a customer to “click” on a hypertext link, which accesses the proprietor's computer system. This hypertext link would already carry an item identifier with it. The item identifier would then be processed by method 100 as further described below. However, by clicking on a hypertext link offering one or two items only, the customer is not introduced to the full range of item offerings which a proprietor might have on its computer system. Therefore, a browsable catalogue of items, accessible to a customer, is a second, more preferable way of introducing a customer to a range of items, and allowing the customer to select as many items as it desires.

In operation, a browsable catalogue of items 130 and item categories 410, 410A could be accessed on a customer's computer screen, when the customer “clicks through” to a proprietor's Web site. The structure of browsable catalogue seen by the customer is preferably similar to the browsable catalogue used by the subscriber or proprietor, as already described at position 630 on subscriber form 600. This catalogue of item categories 410, 410A can be very broad or narrow in nature, as already noted. Starting with a broad catalogue tree would be useful to the customer who does not know the specific item it wants to purchase, but who knows the general item categories 410, 410A in which an item might be located. Upon finding the broad item category, the customer can drill down the catalogue tree until a specific item 130 is located. Likewise, if the customer already knows the item it wants to purchase, it can merely proceed directly to the item 130 in the catalogue tree.

Each item has an associated item identifier 405 and each category has an associated item category identifier 412, 412A, as described previously, but in the preferred embodiment, these identifiers are unseen by the customer, and only the item categories 410, 410A and specific items 130 are visible to the customer. Upon selecting an item, the customer would also enter its address and other biographical information, as well as any additional information that the computer system might prompt the customer to enter. Such further additional information might include the entry by the customer of a user level as previously described, but the invention is not limited as to the type and quality of information which might be entered by the customer. This customer information can be stored by computer system 110 for purposes of future marketing campaigns, for example.

Any information entered by the customer can be used by computer system 110 to place a strategic piece of collateral 140, as long as the vested party has previously designed a collateral identifier 520 which includes further identifiers corresponding to information supplied by the customer. This collateral identifier 520 is then matched by process 700 (as described further, below) to the information supplied by the customer, and an appropriate piece of collateral is selected to be placed with the item 130. Any customer information which the computer system 110 prompts the customer to enter could be entered by the customer on an online form; such forms being well known in the computer arts.

### The Collateral Matching Process

Upon the customer selecting an item for purchase, and entering the information just described, the collateral matching process 700 of computer system 110 begins. Collateral matching process 700 shown in FIGS. 7 and 7A represent a more detailed representation for carrying out steps 114, 116, and 119 of the general method 100 shown in FIGS. 1 and 2.

The first embodiment of process 700 shown in FIG. 7 represents a process for matching a basic piece of collateral 140 with an item. For example, a vested party might not need or want to supply a multitude of different types of collateral that have been created with different criteria (e.g. country/region specific or user level). In such a case, the embodiment of process 700 shown in FIG. 7 would suffice to result in the placement of a basic piece of uniform collateral with an item or items.

Continuing with FIG. 7 in more detail, the collateral matching process 700 is implemented through a software program which executes the series of steps shown in process 700. In the first step, a sales transaction 120 is executed through computer system 110 to start the collateral matching process 700. The sales transaction 120 can originate from a customer referred to computer system 110 by “clicking” on a hypertext link on an affiliate Web site, which transmits the proprietor's Web site to the customer's computer, for example. Upon receiving the proprietor's Web site on its computer, the customer continues with the sales transaction by entering its biographical information (or any other information it is prompted to enter) and selecting for purchase, an item 130 from the browsable catalogue of items and item categories 410, 410A described previously. The item selected from the browsable catalogue would be compared 121 with the corresponding item identifiers 405 in the items database 400 and upon finding a match, an item identifier would be assigned 122. Next, payment is received 705, from the customer, through a credit card, for example. If payment is not approved 712, a failure message 713 is sent, and process halts 714. However, if payment is approved 708, a payment signal 710 is sent through computer system 110, which includes the item identifier 405, which is attached 123 to the payment signal. Next, process 700 extracts 715 the item identifier 405 for the selected item 130, from the payment signal 710.

The item identifier 405 extracted 715 from the payment signal 710 is compared 124 to the collateral identifiers 520 in subscriber database 500. Next, following comparison, one or more collateral identifiers 520 having a match 720 to the item identifier 405 are selected by computer system 110. For example, referring to FIG. 4, if the customer selects book item 130 entitled “Gardening in Alaska,” having the item identifier 405 of I543, which matches to the collateral identifier 520 of 345IC42, because this item is encompassed in this item category, which was selected by a vested party in the manner already described. After a first match is made process 700 continues comparing all collateral identifiers 520 from subscriber database 500 and matches all other collateral identifiers 520 which are associated with the item identifier 405, or else have an item category identifier 412, 412A, which is associated with the item identifier.

If an item category 410, 410A is selected to be matched with collateral 140 by a vested party, all items 130 listed under that category 410, 410A will be targeted with the collateral 140. However, if only a single item 130 is selected by the vested party, and no category is selected, only that single item will be targeted with the collateral 140.

After all collateral identifiers are matched to the item, and any associated item categories, a pick list 180 is generated 725, which directs the manual or automated placement of collateral 140 with the item 130. This brings the collateral matching process 700 to an end 730. After the collateral is matched with the item, the container enclosing both the item and collateral is shipped to its destination.

The second embodiment of process 700 shown in FIG. 7A represents a process for matching a collateral piece or pieces having additional information, such as country or user level. The customer, would enter any information it is prompted to enter, upon beginning the sales transaction 120, as described above. However, with this embodiment, this information would be applied by process 700 in a manner whereby strategic collateral could ultimately be placed with the shipped item 130 in accordance with the information entered by the customer.

The information corresponds to the “additional” information noted previously in the section referring to building strategic collateral identifiers by adding identifiers relating to the additional information to a basic collateral identifier. Such additional information could be country or region specific information. For the sake of example, process 700 shown in FIG. 7A would correspond postal code information extracted from a customer's address information with collateral identifiers having country or region identifiers corresponding to postal codes located in the customer's address information.

As shown in FIG. 7A, upon the customer entering its address information, process 700 would search the address information for country or region designators, such as a postal code. Upon finding the postal code, the process would compare 126 this postal code to a data base 900 of postal codes contained on computer system 110. Such a postal code database 900 could be added to the computer system architecture as shown in FIG. 3A along with the other databases shown. The postal code database 900 would preferably include country or region identifiers (e.g. “ME” as an identifier for Mexico) corresponding to each of a plurality of postal codes. The ME identifier for Mexico would correspond to postal codes there; likewise a US identifier would correspond to those postal codes in the United States, and so on. Upon comparing the postal code entered by the customer to the postal code database, process 700 would next assign 127 a matching country or region identifier from the database 900 and attach this identifier to the payment signal along with the item identifier. Next, process 700 would compare the item identifier 405 and country/region identifier to collateral identifiers 520 in subscriber database 500 which are associated with the item, and, which also have the country/region identifier as part of the collateral identifier 520.

Process 700 shown in FIG. 7A also accommodates a first instance where an item identifier 405 might match up with a collateral identifier 520, but none of the collateral identifiers 520 carry any additional identifiers (e.g. country/region identifiers, user level identifiers), or else in a second instance where the identifier(s) sent with the payment signal match with the item identifier, but do not match with any additional identifiers inputted by the customer (e.g. where the customer inputs a postal code for Malawi, but the subscriber has not entered any Malawi-specific additional identifiers in the subscriber database, and consequently has not supplied any Malawi-specific collateral). In these instances, the default basic collateral identifier 520 described previously, herein, would be indicated on pick list 180.

### The Pick List

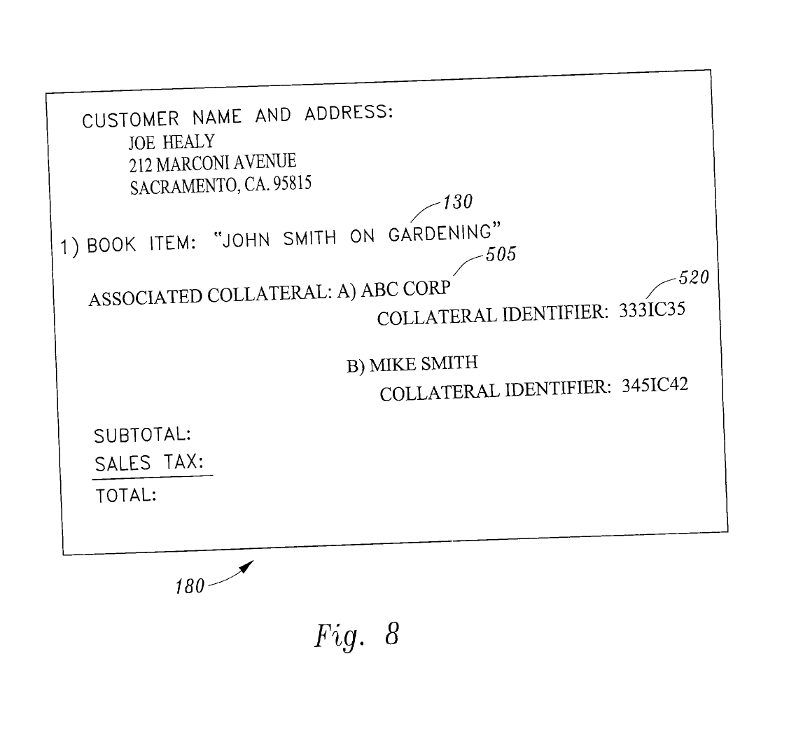

FIG. 8 illustrates a preferred pick list 180 for the manual placement of collateral 140. Here the pick list 180 is an invoice which lists various indicia for identifying the collateral to be placed with the purchased item 130. The indicia are preferably collateral identifiers 520, as well as some biographical data 505 on the subscriber who is the source of the collateral 140. Such an invoice-style pick list aids shipping personnel to manually place the collateral according to the collateral identifier 520. Alternately, the pick list can be a set of digital instructions sent by computer system 110 to a print-on-demand component of system 110, which prints the collateral 140, and automatically places it in a container 150 with the item 130 for shipment. Such a print-on-demand system can be especially efficient where a vested party has multiple collateral pieces 140 designed with multiple criteria (e.g. country/region, user level).

### Combining Commission Affiliates with the Method

Note that while the method described so far herein is directed to subscribers who may come upon the proprietor's Web site in random fashion, and subscribe, the method described herein is most manageable when the subscribers are “affiliates” of the proprietor. Namely, such affiliates have prior agreements with the proprietor to represent the proprietor's items on an affiliate Web site, and in return, the proprietor agrees to place the collateral of these specified affiliates with items sold, and pay the affiliates a commission for any sales of items referred from such an affiliate Web site through a hypertext link on the affiliate Web site identifying an item being sold on the proprietor's Web site. In such a case, the collateral identifier 520 might include additional code (an affiliate identifier) relating to compensation information for an affiliate, so that the source of the referral is identified and a commission is recorded by system 110 for the affiliate, each time a sale is referred from the affiliate's Web site.

Finally, although the description above contains many specificities, these should not be construed as limiting the scope of the invention, but as merely providing illustrations of some of the presently preferred embodiments of this invention. Thus the scope of this invention should be determined by the appended claims and their legal equivalents.

I claim:

1) A method for matching collateral with an item purchased by a customer, the method comprising:
a) providing a computer system;
b) matching on the computer system information relating to a piece of collateral with information relating to an item and storing information related to this match in the computer system's memory;
c) executing a transaction for the item through the computer system; and
d) matching the piece of collateral with the item in accordance with the stored information in the computer system's memory.

2) The method of claim 1, further comprising the step of shipping the item and collateral to a destination.

3) The method of claim 1, further comprising the steps of placing the item and collateral in a shipping container and shipping the item and collateral to a desired destination.

4) The method of claim 1, further comprising the steps of generating a pick list containing the stored information on the computer system's memory and using this information for matching the collateral with the item.

5) The method of claim 1, further comprising the steps of generating a digital pick list and sending information contained in this pick list to automated collateral sorting machinery.

6) A method for matching collateral with an item purchased by a customer, the method comprising:
a) providing a computer system with a database for storing information on an item available for sale;
b) allowing a subscriber to subscribe to the computer system;
c) matching the subscriber to a piece of collateral and storing information relating to this match in a database on the computer system;
d) transacting a sale of the item for a customer through the computer system; and
e) matching the item with the piece of collateral matched to the subscriber according to the information stored on the computer system.

7) The method of claim 6, further comprising the step of shipping the item and collateral to a destination.

8) The method of claim 6, further comprising the steps of placing the item and collateral in a shipping container and shipping the item and collateral to a desired destination.

9) The method of claim 6, further comprising the steps of generating a pick list containing the stored information in the computer system's database and using this information for matching the collateral with the item.

10) The method of claim 6, further comprising the steps of generating a digital pick list and sending information contained in this pick list to automated collateral sorting machinery.

12) A method for matching an item sold through a computer sales transaction with a piece of collateral, the method comprising:
a) providing a computer system having a catalogue of items, each item being assigned an item identifier, the item identifier being stored within a computer memory on the computer system;
b) matching at least one item identifier with at least one piece of collateral; and
c) transacting a sale by a customer of the computer system, the sales transaction causing the computer system to generate a pick list matching at least one item purchased from the sale with at least one piece of collateral.

13) A method for matching an item sold through a computer sales transaction with a piece of collateral, the method comprising:
a) providing a computer system having a catalogue of items, each item being assigned an item identifier, the item identifier being stored within a computer memory on the computer system;
b) matching collateral identifiers to corresponding pieces of collateral and storing information related to this match within a computer memory on the computer system;
c) matching at least one item identifier with at least one collateral identifier;
d) instigating a sales transaction for an item through a customer accessing the computer system and selecting an item for purchase, the customer further inputting customer information; and
e) completing the sales transaction by generating a pick list matching at least one item purchased from the sale with at least one collateral identifier corresponding to a piece of collateral.

14) The method of claim 13, wherein said matching of at least one item identifier with at least one collateral identifier occurs through the computer system generating a collateral identifier having an item identifier incorporated into the collateral identifier.

15) The method of claim 13, wherein said matching of at least one item identifier with at least one collateral identifer occurs through the computer system generating a collateral identifier having an item category identifier incorporated into the collateral identifier.

16) The method of claim 14 or claim 15, further comprising the step of creating a strategic collateral identifier by attaching additional identifiers to the collateral identifier.

17) The method of claim 16, wherein one of the additional identifiers is a country or region specific identifier.

18) The method of claim 16, wherein one of the additional identifiers is a user level identifier.

19) The method of claim 16, wherein upon inputting customer information, the inputted information is compared to an information database and an additional identifier corresponding to the inputted information is assigned by the computer system and attached to a payment signal along with the item identifier.

20) The method of claim 19, further comprising the steps of extracting the item identifier and additional identifier from the payment signal and comparing the item identifier and additional identifier to a database of collateral identifiers present on the computer system.

21) The method of claim 20, further comprising the steps of matching the item identifier and additional identifier to at least one collateral identifier in the database of collateral identifiers and sending this collateral identifier to be generated with the pick list.

22) The method of claim 21, wherein if no match is made a default collateral identifier is sent to be generated with the pick list.

23) The method of claim 19, wherein said additional identifier corresponds to a postal code.

24) The method of claim 19, wherein said additional identifier corresponds to a user level.

25) A method for allowing a subscriber to create a custom collateral marketing program upon a second party's computer system, the method comprising:
a) providing a computer system that includes a catalogue of items, stored within the computer system's memory;
b) providing the subscriber with access to the computer system and allowing the subscriber to match a piece of collateral with one or more items in the catalogue of items; and
c) transacting a sale by a customer of the computer system, the sales transaction causing the computer system to generate a pick list matching at least one item purchased from the sale with at least one piece of collateral chosen by the subscriber to be matched with the item.

26) The method of claim 25, further comprising the step of shipping the item and collateral to a destination.

27) A method for matching collateral with the purchasing habits of a customer referred from a hypertext link, the method comprising:
a) providing a computer system that includes a catalogue of items with corresponding item identifiers stored in the computer system's memory;
b) matching the items in the catalogue of items with collateral and storing information relating to this match in the computer system's memory;
c) providing a hypertext link to the computer system, the hypertext link containing an item identifier relating to an item in the catalogue of items;
d) receiving a payment signal from a customer clicking on the hypertext link for the item, the payment signal containing the item identifier;
e) transacting a purchase of the item by the customer;
f) matching the item with a piece of collateral according to the information stored in the computer system's memory; and
g) shipping the item and collateral to a destination.

28) A computer system for matching collateral to an item purchased, the system comprising:
a) a central processing unit;
b) a random access memory;
c) a read only memory;
d) a clock; and
e) a data storage device storing information for strategically matching items to collateral.

29) The computer system of claim 28, wherein the data storage device further comprises an items database, a subscriber database and software means for matching items to collateral.

30) The computer system of claim 29, wherein said items database is structured in the form of item categories, item subcategories and items.

31) The computer system of claim 30, wherein said item categories and subcategories have associated item category identifiers and said items have associated item identifiers.

32) The computer system of claim 29, wherein said subscriber database further comprises biographical information on subscribers, collateral identifiers and subscriber identifiers.

33) The computer system of claim 28, wherein said data storage device further comprises an items database, a subscriber database, and a collateral matching process implemented through software.

34) The computer system of claim 33, wherein said collateral matching process operates to match a piece of collateral with an item upon the instigation of a transaction for the item.

35) The computer system of claim 33, wherein said collateral matching process operates to match a piece of collateral with an item by matching an item identifier with a collateral identifier upon the instigation of a transaction for the item.

36) A method for linking an affiliate commission sale transacted through a computer with a collateral marketing program, the method comprising:
a) providing a computer system which assigns an affiliate identifier, this affiliate identifier being stored within a computer memory on the computer system;
b) providing a database on the computer system having a catalogue of items, each item being assigned an item identifier, the item identifier being stored within a computer memory on the computer system;
c) associating each item with at least one piece of collateral;
d) transacting a sale of an item referred from an affiliate Web site through a customer clicking on a hypertext link on the affiliate Web site that is associated with an item sold on the computer system, the hypertext link containing an item identifier and affiliate identifier;
e) identifying the source of the referral through the computer system recognizing the affiliate identifier; and
f) recording a commission for an affiliate from whom the sale was referred.

37) The method of claim 36, further comprising the step of shipping the item and its chosen collateral to a destination.

38) The method of claim 36, further comprising the steps of placing the item and collateral in a shipping container and shipping the item and collateral to a desired destination.

39) The method of claim 36, further comprising the steps of generating a pick list containing the stored information on the computer system's memory and using this information for matching the collateral with the item.

40) The method of claim 36, further comprising the steps of generating a digital pick list and sending information contained in this pick list to automated collateral sorting machinery.
